(19) United States
(12) Patent Application Publication
(10) Pub. No.: US 2022/0086755 A1
(43) Pub. Date: Mar. 17, 2022

(54) CONTROL DEVICE AND NON-TRANSITORY COMPUTER READABLE STORAGE MEDIUM

(71) Applicant: KABUSHIKI KAISHA TOKAI RIKA DENKI SEISAKUSHO, Aichi (JP)

(72) Inventors: Masateru FURUTA, Aichi (JP); Shigenori NITTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/400,582

(22) Filed: Aug. 12, 2021

(30) Foreign Application Priority Data
Sep. 11, 2020 (JP) 2020-153197

(51) Int. Cl. H04W 52/02; H04W 52/24; H04W 4/38

(52) U.S. Cl. CPC H04W 52/0229; H04W 4/38; H04W 52/245

(57) ABSTRACT

To effectively extend a time that passes until an operation is disabled.

There is provided a control device comprising: a control section configured to control wireless communication of a wireless communication section that conforms to predetermined communication standards, wherein the control section controls execution of distance measurement based on the wireless communication according to a voltage to be applied.

### CROSS REFERENCE TO RELATED APPLICATION(S)

This application is based upon and claims benefit of priority from Japanese Patent Application No. 2020-153197, filed on Sep. 11, 2020, the entire contents of which are incorporated herein by reference.

### BACKGROUND

The present invention relates to a control device and a non-transitory computer readable storage medium.

In recent years, a technology that performs various processes according to a result of transmission and reception of wireless signals between devices has been developed. For example, following JP2020-118030 discloses a technology that measures a distance between devices by using an Ultra Wide Band (UWB) signal.

### SUMMARY

There is a case where the above-described system notifies a user of that a voltage to be applied from a battery goes below a certain threshold in a portable device carried by the user. However, since a time that passes until a voltage reaches a voltage at which an operation of the portable device is disabled after the notification is given is short, there is a case where a problem occurs upon use of the portable device.

Therefore, the present invention has been made in light of the above problem, and an object of the present invention is to effectively extend a time that passes until an operation is disabled.

To solve the above described problem, according to an aspect of the present invention, there is provided a control device comprising: a control section configured to control wireless communication of a wireless communication section that conforms to predetermined communication standards, wherein the control section controls execution of distance measurement based on the wireless communication according to a voltage to be applied.

To solve the above described problem, according to another aspect of the present invention, there is provided a non-transitory computer readable storage medium having a program stored therein, the program causing a computer to realize: a control function configured to control wireless communication of a wireless communication section that conforms to predetermined communication standards, wherein the program causes the control function to control execution of distance measurement based on the wireless communication according to a voltage to be applied.

As described above, according to the present invention, it is possible to effectively extend a time that passes until an operation is disabled.

### BRIEF DESCRIPTION OF THE DRAWINGS

FIG. 1 is a diagram illustrating a configuration example of a system 1 according to an embodiment of the present invention.

FIG. 2 is a view for explaining an influence of distance measurement control on a battery charge according to the embodiment.

FIG. 3 is a sequence diagram illustrating a flow of a series of processes executed between a portable device 10 and in-vehicle equipment 20 according to the embodiment.

FIG. 4 is a sequence diagram illustrating an example of distance measurement control of a control section 110 according to the embodiment.

FIG. 5 is a sequence diagram illustrating an example of distance measurement control of the control section 110 according to the embodiment.

FIG. 6 is a sequence diagram illustrating an example of a flow of a series of processes repeatedly executed between the portable device 10 and the in-vehicle equipment 20 before a voltage to be applied from a battery 140 goes below a threshold Vt according to the embodiment.

FIG. 7 is a sequence diagram illustrating an example of a flow of a series of processes executed between the portable device 10 and the in-vehicle equipment 20 after the voltage to be applied from the battery 140 goes below the threshold Vt according to the embodiment.

FIG. 8 is a flowchart illustrating an example of a flow of distance measurement control of the control section 110 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

<<1.1. System Configuration Example>>

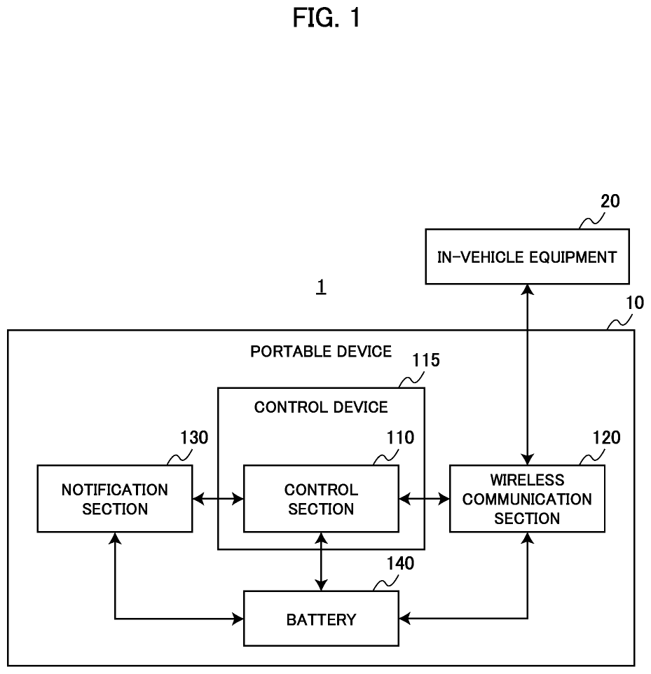

First, the system configuration example of a system 1 according to the embodiment of the present invention will be described. FIG. 1 is a diagram illustrating the configuration example of the system 1 according to the present embodiment.

As illustrated in FIG. 1, the system 1 according to the present embodiment may include a portable device 10 and in-vehicle equipment 20.

(Portable Device 10)

The portable device 10 according to the present embodiment is an example of a wireless communication device that performs wireless communication that conforms to predetermined communication standards. For example, the portable device 10 according to the present embodiment may perform the above wireless communication with the in-vehicle equipment 20.

The portable device 10 according to the present embodiment may be, for example, a smartphone, a wearable device, or dedicated equipment.

As illustrated in FIG. 1, a control device 115 including at least a control section 110 is mounted on the portable device 10 according to the present embodiment. Furthermore, the portable device 10 according to the present embodiment may include a wireless communication section 120, a notification section 130, and a battery 150.

(Control Section 110)

The control section 110 according to the present embodiment controls wireless communication that conforms to predetermined communication standards of the wireless communication section 120.

The predetermined communication standards according to the present embodiment are, for example, ultra wide band wireless communication. In this case, the control section 110 according to the present embodiment controls transmission and reception of an ultra wide band signal (also referred to as a UWB signal below) of the wireless communication section 120.

On the other hand, the predetermined communication standards according to the present embodiment are not limited to the above example. The predetermined communication standards according to the present embodiment may be wireless communication that uses, for example, Bluetooth (registered trademark) Low Energy (BLE) or signals of a Low Frequency (LF) range and an Ultra High Frequency (UHF) range. Even in this case, the control section 110 according to the present embodiment controls transmission and reception of a signal that conforms to the predetermined communication standards of the wireless communication section 120.

Furthermore, one of features of the control section 110 according to the present embodiment is to control execution of distance measurement based on wireless communication that conforms to the above predetermined communication standards according to a voltage to be applied from the battery 140.

When, for example, the predetermined communication standards are ultra wide band wireless communication, the control section 110 controls transmission of the wireless communication section 120 of a first distance measurement signal, and reception of the wireless communication section 120 of a second distance measurement signal that is transmitted as a response to the first distance measurement signal by the in-vehicle equipment 20.

Hereinafter, distance measurement based on the above first distance measurement signal and second distance measurement signal will be briefly described.

Distance measurement according to the present embodiment refers to performing calculation based on the first distance measurement signal and the second distance measurement signal, and calculating a distance measurement value that is an estimation value of a distance between the portable device 10 and the in-vehicle equipment 20 (more precisely, between the wireless communication section 120 included in the portable device 10 and a wireless communication section included in the in-vehicle equipment 20).

Distance measurement according to the present embodiment can be executed based on a time ΔT1 from a time at which the wireless communication section 120 transmits the first distance measurement signal to a time at which the wireless communication section 120 receives the second distance measurement signal, and a time ΔT2 from a time at which the in-vehicle equipment 20 receives the first distance measurement signal to a time at which the in-vehicle equipment 20 transmits the second distance measurement signal.

More specifically, it is possible to calculate a time required for round-trip communication of distance measurement signals by subtracting the time ΔT2 from the time ΔT1, and, furthermore, calculate a time required for one-way communication of the distance measurement signals by dividing the time by 2. Furthermore, by multiplying a value of (time ΔT1−time ΔT2)/2 with a speed of a signal, it is possible to calculate a distance measurement value.

Distance measurement control of the control section 110 according to the present embodiment will be separately described in detail.

Furthermore, the control section 110 according to the present embodiment may control wireless communication that conforms to other communication standards different from the predetermined communication standards of the wireless communication section 120.

When, for example, the predetermined communication standards are ultra wide band wireless communication, the above other communication standards may employ wireless communication that uses BLE or signals of the LF range and the UHF range.

In addition, a function of the control section 110 according to the present embodiment is realized by various processors such as a CPU.

(Wireless Communication Section 120)

The wireless communication section 120 according to the embodiment performs wireless communication that conforms to the predetermined wireless communication standards according to control of the control section 110.

For example, the wireless communication section 120 according to the present embodiment may transmit a signal that conforms to the predetermined communication standards, or stand by to receive the signal that conforms to the predetermined communication standards according to control of the control section 110.

(Notification Section 130)

The notification section 130 according to the present embodiment gives various notifications to a user according to control of the control section 110. For example, the notification section 130 according to the present embodiment may give a notification that indicates that a battery charge is little according to control of the control section 110.

Hence, the notification section 130 according to the present embodiment includes a display that displays characters, a speaker that outputs a voice or a beep sound, a lighting that emits light, and an actuator that causes vibration.

The notification according to the present embodiment may be performed by using one or a combination of the above-described configurations.

(Battery 140)

The battery 140 according to the present embodiment supplies electric power to each component included in the portable device 10. An example of the battery 140 according to the present embodiment is, for example, a lithium ion battery.

The battery 140 according to the present embodiment may have a capacity and a shape matching characteristics of the portable device 10.

(In-Vehicle Equipment 20)

The in-vehicle equipment 20 according to the present embodiment is an example of the wireless communication device that performs wireless communication that conforms to the predetermined communication standards. For example, the in-vehicle equipment 20 according to the present embodiment may perform the above wireless communication with the portable device 10.

The in-vehicle equipment 20 according to the present embodiment is mounted on a movable body such as a vehicle that the user who carries the portable device 10 uses.

Furthermore, the in-vehicle equipment 20 according to the present embodiment may control a target control device such as a door or an engine included in the movable body to be mounted based on a result of a process that uses the above wireless communication.

When, for example, the portable device 10 is verified as a legitimate communication party, and the distance between the portable device 10 and the in-vehicle equipment 20 is estimated as a predetermined value or less as a result of a series of processes including distance measurement, the in-vehicle equipment 20 according to the present embodiment may permit the above door to unlock or the above engine to start.

A detailed functional configuration of the in-vehicle equipment 20 according to the present embodiment will be omitted. However, the in-vehicle equipment 20 may include, for example, the wireless communication section that performs wireless communication with the portable device 10, and a control section that controls the wireless communication section or the above target control device.

The configuration example of the system 1 according to the present embodiment has been described above. In addition, the above configuration described using FIG. 1 is only an example, and the configuration of the system 1 according to the present embodiment is not limited to this example.

For example, FIG. 1 exemplifies the case where the control device 115 according to the present embodiment includes only the control section 110. However, the control device 115 according to the present embodiment may further include the wireless communication section 120 and the notification section 130.

The configuration of the system 1 according to the present embodiment can be flexibly modified according to a specification or an operation.

<<1.2. Details of Control>>

Next, distance measurement control of the control device 115 according to the present embodiment will be described in detail. First, an influence of distance measurement control on a battery charge according to the present embodiment will be described.

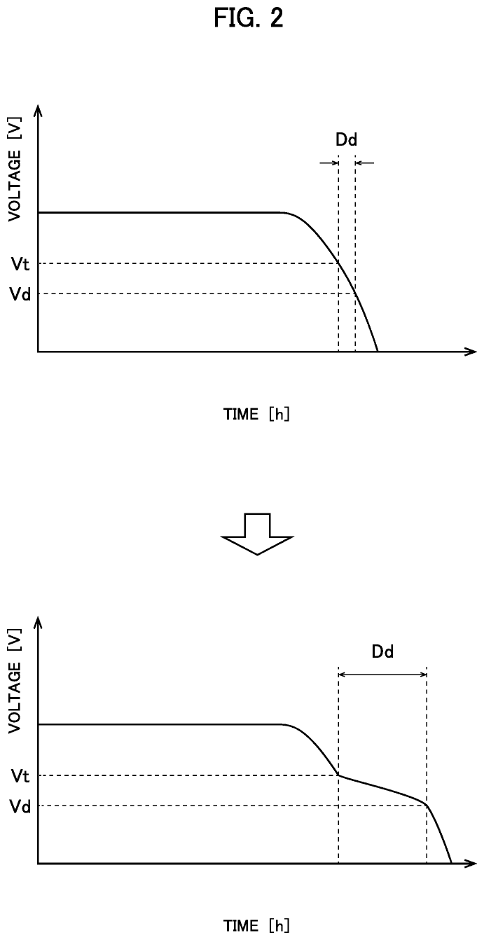

FIG. 2 is a view for explaining the influence of distance measurement control on the battery charge according to the present embodiment.

An upper part in FIG. 2 illustrates a graph that shows in chronological order a voltage [V] to be applied from the battery 140 in a case where distance measurement control is not performed according to the present embodiment.

As illustrated in the graph, the voltage to be applied from the battery 140 rapidly lowers when a certain period of time passes, and reaches a certain threshold Vt. When, for example, the voltage to be applied from the battery 140 goes below the threshold Vt, the control section 110 may cause the notification section 130 to give a notification that indicates that the battery charge is little.

However, when distance measurement control according to the present embodiment is not performed, and normal distance measurement is performed, the voltage reaches a voltage Vd at which the operation of the portable device 10 is disabled immediately after the voltage goes below the threshold Vt as illustrated in the graph in the upper part in FIG. 2, and a situation that the portable device 10 cannot be used occurs.

On the other hand, a lower part in FIG. 2 illustrates a graph that shows in chronological order a voltage [V] to be applied from the battery 140 in a case where distance measurement control according to the present embodiment is performed.

As illustrated in the graph, when distance measurement control according to the present embodiment is performed, it is possible to effectively extend a duration Dd in which the voltage reaches the voltage Vd at which the operation of the portable device 10 is disabled after the voltage goes below the threshold Vt.

Distance measurement control that realizes the above effect will be described in detail below.

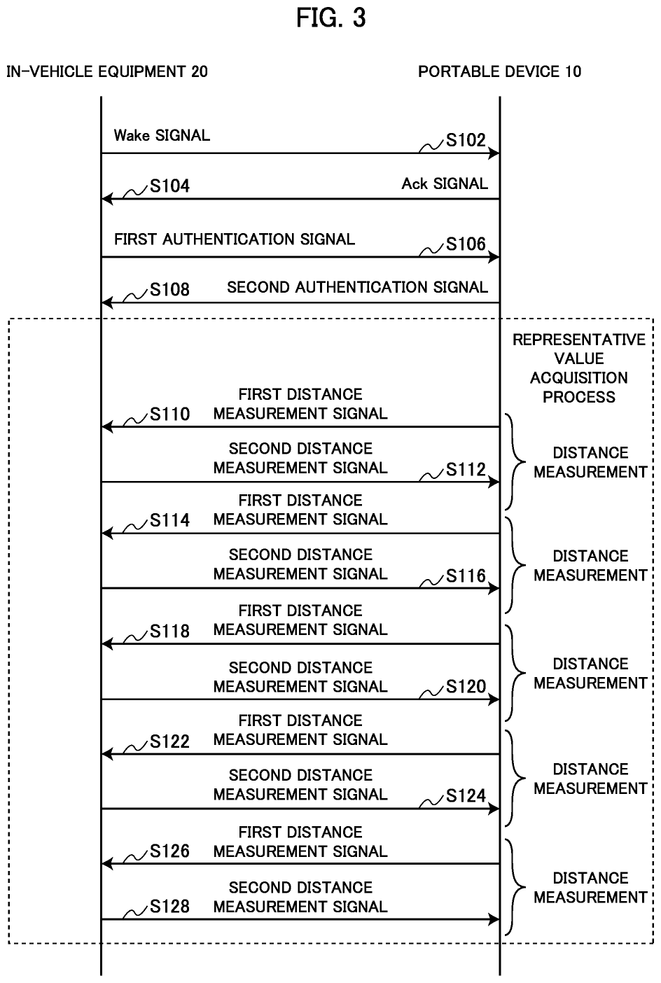

FIG. 3 is a sequence diagram illustrating a flow of a series of processes executed between the portable device 10 and the in-vehicle equipment 20 according to the present embodiment. The portable device 10 and the in-vehicle equipment 20 according to the present embodiment may execute a series of processes according to the flow illustrated in FIG. 3 before the voltage to be applied from the battery 140 goes below the threshold Vt.

As illustrated in FIG. 3, the in-vehicle equipment 20 first transmits a Wake (Wake up) signal that is a signal that instructs activation (S102).

Next, the control section 110 of the portable device 10 causes the wireless communication section 120 to transmit an Ack (Acknowledgement) signal that is an acknowledgement that indicates to perform activation, based on that the wireless communication section 120 has received the Wake signal in step S102 (S104).

Next, the in-vehicle equipment 20 that has received the Ack signal in step S104 transmits the first authentication signal that requests information for authenticating authenticity of the portable device 10 (S106).

Next, the control section 110 of the portable device 10 causes the wireless communication section 120 to transmit the second authentication signal including information used by the in-vehicle equipment 20 to authenticate the portable device 10 based on that the wireless communication section 120 has received the first authentication signal in step S106 (S108).

Next, the in-vehicle equipment 20 executes authentication of the portable device 10 based on the second authentication signal received in step S108 (not illustrated).

In addition, the first authentication signal according to the present embodiment may include, for example, a random number. In this case, the information included in the above second authentication signal may include the above random number, a password, and a hash value calculated by using a hash function. The in-vehicle equipment 20 may verify the authenticity of the portable device 10 when the hash value included in the second authentication signal is a correct value.

Furthermore, the Wake signal, the Ack signal, the first authentication signal, and the second authentication signal according to the present embodiment may be signals that conform to other communication standards different from the predetermined communication standards.

When, for example, the predetermined communication standards are ultra wide band wireless communication, the Wake signal, the Ack signal, the first authentication signal, and the second authentication signal may be signals of the LF range or the UHF range.

When the above-described authentication process that uses the first authentication signal and the second authentication signal is finished, the portable device 10 and the in-vehicle equipment 20 execute a representative value acquisition process.

The representative value acquisition process according to the present embodiment may be a process of, for example, performing distance measurement a plurality of times, and obtaining a representative value that is estimated to precisely reflect the distance between the portable device 10 and the in-vehicle equipment 20 based on a plurality of distance measurement values calculated by each distance measurement.

For example, in a case of the example illustrated in FIG. 3, the representative value acquisition process includes five times of distance measurement that include in the first place distance measurement based on the first distance measurement signal that the control section 110 causes the wireless communication section 120 to transmit in step S110, and the second distance measurement signal that the in-vehicle equipment 20 transmits as the response to the first distance measurement signal in step S112.

In this case, the in-vehicle equipment 20 may acquire as a representative value a distance measurement value that is the smallest (i.e., indicates the shortest distance) among the distance measurement values calculated by each distance measurement.

In addition, the control section 110 of the portable device 10 may cause the wireless communication section 120 to transmit information related to the above-described time ΔT2 such that the in-vehicle equipment 20 calculates the distance measurement value during each distance measurement (not illustrated).

On the other hand, by setting and sharing the fixed time ΔT2 in advance, the in-vehicle equipment 20 can calculate the distance measurement value without transmitting and receiving the above information.

When it is estimated that the portable device 10 is located within a predetermined distance from the in-vehicle equipment 20 based on the representative value acquired as described above, and the authenticity of the portable device 10 is verified by the authentication process based on the first authentication signal and the second authentication signal, the in-vehicle equipment 20 according to the present embodiment may permit the door included in the movable body to unlock or the engine to start.

In addition, the first distance measurement signal and the second distance measurement signal according to the present embodiment may be signals that conform to the predetermined communication standards. The predetermined communication standards according to the present embodiment can employ, for example, ultra wide band wireless communication.

The flow of a series of processes executed between the portable device 10 and the in-vehicle equipment 20 according to the present embodiment has been described above.

As described above, the portable device 10 and the in-vehicle equipment 20 according to the present embodiment may execute a series of processes according to the flow illustrated in FIG. 3 before the voltage to be applied from the battery 140 goes below the threshold Vt.

On the other hand, even when the voltage to be applied from the battery 140 goes below the threshold Vt, and when a series of processes are executed according to a similar flow, the voltage rapidly lowers, and the duration Dd in which the voltage reaches the voltage Vd at which the operation of the portable device 10 is disabled after the voltage goes below the threshold Vt becomes short as illustrated in the graph illustrated in the upper part in FIG. 2.

The technical idea of the present invention has been conceived focusing on the above point, and effectively extends the time that passes until the operation of the portable device 10 is disabled, and improves user friendliness.

Hence, one of features of the control section 110 according to the present embodiment is to control execution of distance measurement based on wireless communication that conforms to the predetermined communication standards according to the voltage to be applied from the battery 140.

For example, the control section 110 according to the present embodiment may control the number of times of execution of distance measurement according to the voltage to be applied from the battery 140.

More specifically, when the voltage to be applied from the battery 140 goes below the threshold Vt, the control section 110 according to the present embodiment may perform control to suppress the number of times of the distance measurement to the number of times matching the threshold Vt.

According to the above-described control, it is possible to suppress power consumption by reducing the number of times of distance measurement, and effectively extend the time that passes until the operation of the portable device 10 is disabled.

Furthermore, for example, the control section 110 according to the present embodiment may control a distance measurement execution interval according to the voltage to be applied from the battery 140.

More specifically, when the voltage to be applied from the battery 140 goes below the threshold Vt, the control section 110 according to the present embodiment may perform control to be able to suppress the distance measurement execution interval to an interval matching the threshold Vt.

According to the above-described control, it is possible to avoid rapid power consumption by reducing the distance measurement interval, and effectively extend the time that passes until the operation of the portable device 10 is disabled.

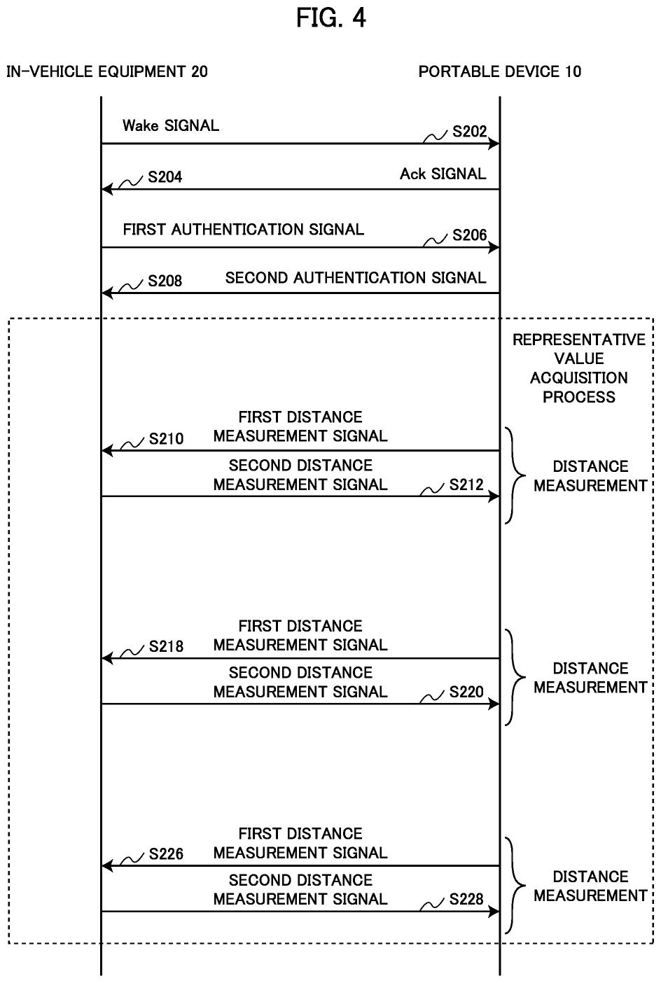

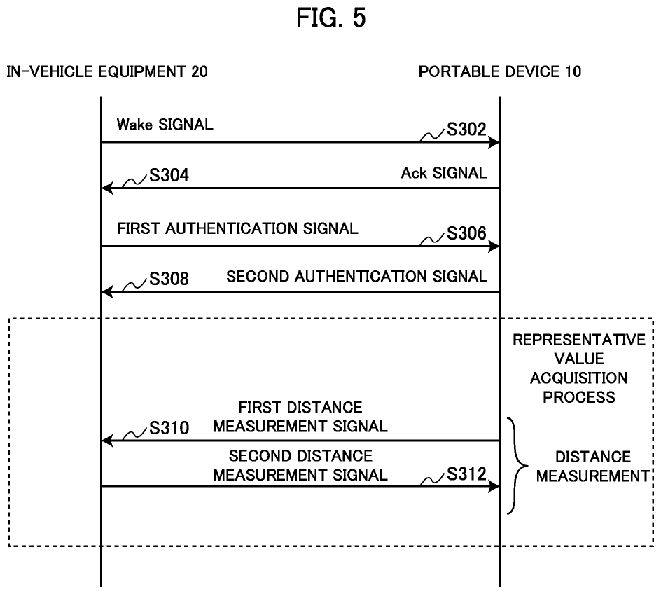

Description will continue below referring to a specific control example. FIGS. 4 and 5 are sequence diagrams illustrating one example of distance measurement control of the control section 110 according to the present embodiment.

For example, in a case of the example illustrated in FIG. 4, the control section 110 performs control to reduce the number of times of distance measurement executed by the representative value acquisition process to three times compared to the example illustrated in FIG. 3. Furthermore, the control section 110 may perform control to increase each distance measurement interval.

Upon comparison between FIGS. 3 and 4, it is possible to confirm that transmission and reception of the distance measurement signals corresponding to each of steps S114, S116, S122, and S124 in FIG. 3 are not performed in the example illustrated in FIG. 4.

According to the above-described control, by reducing the number of times of distance measurement and increasing the execution interval, it is possible to effectively extend the time that passes until the operation of the portable device 10 is disabled.

Furthermore, in a case of the example illustrated in FIG. 5, the control section 110 performs control to further reduce the number of times of distance measurement executed by the representative value acquisition process, and perform distance measurement only once compared to the example illustrated in FIG. 4.

In this case, it is possible to further suppress power consumption of the battery 140, and, eventually, it is possible to further extend the time that passes until the operation of the portable device 10 is disabled.

In addition, the control section 110 according to the present embodiment may switch between control illustrated in FIG. 4 and control illustrated in FIG. 5 according to the voltage to be applied from the battery 140.

When, for example, the voltage to be applied from the battery 140 goes below a threshold Vt1 (e.g., 30% of a maximum voltage), the control section 110 may perform distance measurement control illustrated in FIG. 4.

Furthermore, when, for example, the voltage to be applied from the battery 140 goes below a threshold Vt2 (e.g., 10% of a maximum voltage), the control section 110 may perform distance measurement control illustrated in FIG. 5.

According to the above-described stepwise control, it is possible to set a priority of representative value precision improvement and a priority of power saving in a more detailed manner.

Furthermore, the control section 110 according to the present embodiment may control the number of times or a frequency of the representative value acquisition processing according to the voltage to be applied from the battery 140.

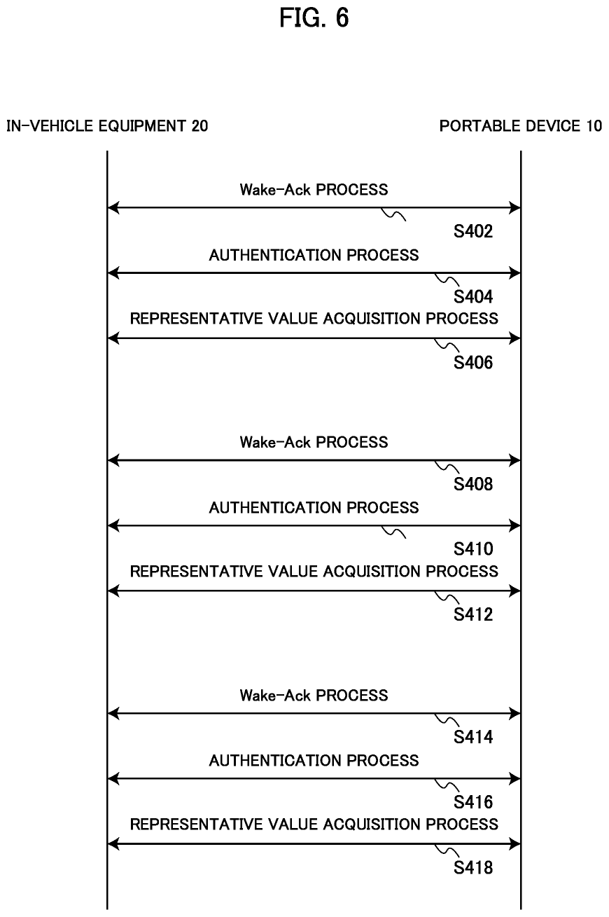

FIG. 6 is a sequence diagram illustrating an example of a flow of a series of processes repeatedly executed between the portable device 10 and the in-vehicle equipment 20 before the voltage to be applied from the battery 140 goes below the threshold Vt according to the present embodiment.

In a case of the example illustrated in FIG. 6, a Wake-Ack process including transmission and reception of the Wake signal and the Ack signal, the authentication process including transmission and reception of the first authentication signal and the second authentication signal, and the representative value acquisition process are first executed between the portable device 10 and the in-vehicle equipment 20 in steps S402 to S406.

Furthermore, in the case of the example illustrated in FIG. 6, each of the above processes is subsequently executed repeatedly in steps S408 to S412 and S414 to S418.

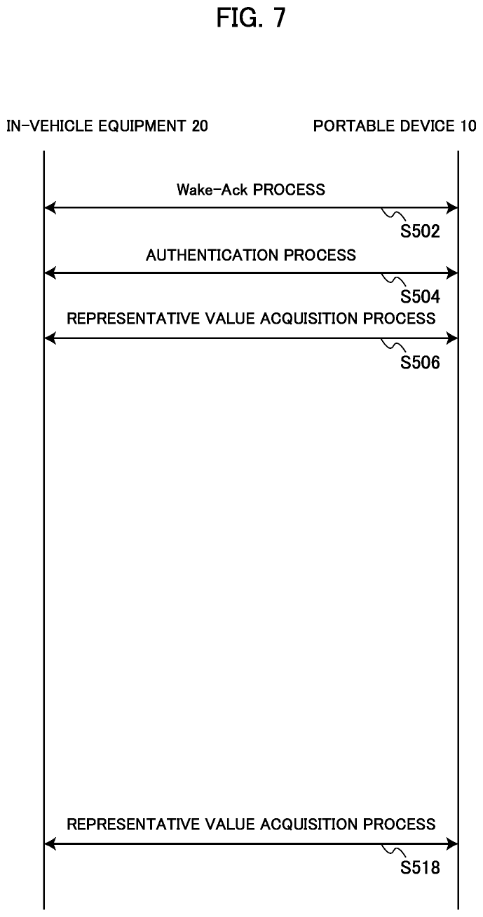

On the other hand, FIG. 7 is a sequence diagram illustrating an example of a flow of a series of processes executed between the portable device 10 and the in-vehicle equipment 20 after the voltage to be applied from the battery 140 goes below the threshold Vt according to the present embodiment.

In a case of the example illustrated in FIG. 7, the control section 110 of the portable device 10 performs control so as to execute the representative value acquisition process only once in step S518 after the Wake-Ack process, the authentication process, and the representative value acquisition process are executed in steps S502 to S506.

That is, the control section 110 performs control so as to not execute a process corresponding to the representative value acquisition process in step S412 in FIG. 6 to reduce the number of times of distance measurement and increase the execution interval.

Furthermore, in the case of the example illustrated in FIG. 7, the control section 110 performs control so as to not execute each process corresponding to the Wake-Ack process in steps S408 and S414 and the authentication process in S410 and S416 in FIG. 6.

Thus, the control section 110 according to the present embodiment may perform control so as to reduce the number of times of execution of each process such as the Ack-Wake process and the authentication process involving transmission and reception of a signal accompanying distance measurement according to the voltage to be applied from the battery 140.

According to the above-described control, it is possible to cut electric power consumed by each process, and it is possible to more effectively extend the time that passes until the operation of the portable device 10 is disabled.

<<1.3 Flow of Control>>

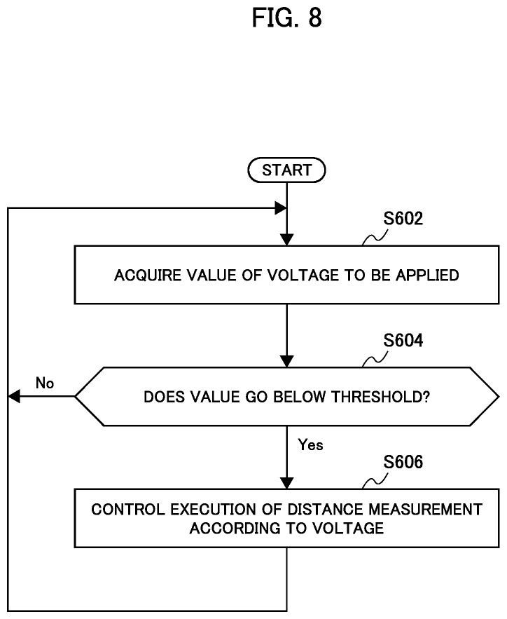

Next, a flow of distance measurement control of the control section 110 according to the present embodiment will be descried in detail. FIG. 8 is a flowchart illustrating an example of a flow of distance measurement control of the control section 110 according to the present embodiment.

As illustrated in FIG. 8, the control section 110 first acquires the value of the voltage to be applied from the battery 140 (S602).

Next, the control section 110 decides whether or not the voltage acquired in step S604 goes below the threshold Vt (S604).

In addition, as described above, according to distance measurement control according to the present embodiment, the plurality of thresholds Vt may be set in a stepwise manner.

In this regard, when the voltage acquired in step S604 is the threshold Vt or more (S604: No), the control section 110 may return to step S602, and repeatedly execute subsequent processes.

On the other hand, when the voltage acquired in step S604 goes below the threshold Vt (S604: Yes), the control section 110 performs distance measurement execution control matching the voltage (S606).

The control section 110 may perform control so as to perform distance measurement according to one or both of the number of times and the interval matching the voltage.

Furthermore, when the voltage goes below the threshold Vt for the first time, the control section 110 may perform control to notify the user of that the battery charge is little.

According to this control, the user can charge or switch the battery 140, and it is possible to avoid a situation that the operation of the portable device 10 is disabled without user's realization.

Furthermore, after control in step S606, the control section 110 may return to step S602, and repeatedly execute the subsequent processes.

### 2. Supplementary Explanation

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

Furthermore, a series of processes of each device described in this description may be realized by using one of software, hardware, and a combination of the software and the hardware. Programs that configure the software are stored in advance in, for example, a non-transitory computer readable storage medium provided inside or outside each device. Furthermore, each program is read on an RAM when, for example, executed by a computer, and is executed by a processor such as a CPU. The above storage medium is, for example, a magnetic disk, an optical disk, a magneto-optical disk, or a flash memory. Furthermore, the above computer programs may be distributed via, for example, a network without using the storage medium.

What is claimed is:

1. A control device comprising:
a control section configured to control wireless communication of a wireless communication section that conforms to predetermined communication standards,
wherein the control section controls execution of distance measurement based on the wireless communication according to a voltage to be applied.

2. The control device according to claim 1,
wherein the control section controls a number of times of execution of the distance measurement according to the voltage to be applied.

3. The control device according to claim 2,
wherein, when the voltage to be applied goes below a threshold, the control section performs control to suppress the number of times of the distance measurement to a number of times matching the threshold.

4. The control device according to claim 1,
wherein the control section controls an execution interval of the distance measurement according to the voltage to be applied.

5. The control device according to claim 4,
wherein, when the voltage to be applied goes below a threshold, the control section performs control to execute the distance measurement at an interval matching the threshold.

6. The control device according to claim 1,
wherein the control section controls a number of times of execution of a process involving transmission and reception of a signal accompanying the distance measurement according to the voltage to be applied.

7. The control device according to claim 1,
wherein, when the voltage to be applied goes below a threshold, the control section performs control to give a notification to a user.

8. The control device according to claim 1,
wherein the predetermined communication standards include ultra wide band wireless communication.

9. The control device according to claim 1,
wherein the control device is mounted on a portable device carried by a user.

10. A non-transitory computer readable storage medium having a program stored therein, the program causing a computer to realize:
a control function configured to control wireless communication of a wireless communication section that conforms to predetermined communication standards,
wherein the program causes the control function to control execution of distance measurement based on the wireless communication according to a voltage to be applied.
